(19) United States
(12) Patent Application Publication
(10) Pub. No.: US 2025/0162673 A1
(43) Pub. Date: May 22, 2025

(54) ADJUSTABLE SEATPOST ASSEMBLY

(71) Applicant: Raphael Schlanger, Wilton, CT (US)

(72) Inventor: Raphael Schlanger, Wilton, CT (US)

(21) Appl. No.: 18/941,166

(22) Filed: Nov. 8, 2024

Related U.S. Application Data
(60) Provisional application No. 63/601,258, filed on Nov. 21, 2023.

(51) Int. Cl. B62J 1/08; B62J 1/02; B62J 1/10

(52) U.S. Cl. CPC B62J 1/08; B62J 1/02; B62J 1/10; B62J 2001/085

(57) ABSTRACT

A seatpost assembly having: a first portion configured to include a seat; a second portion displaceable relative to the first portion in a retracting direction to a first position and an axially extending direction to a second position retracted relative to the first position; and an active motive force to drive the displacement. The range of displacement is between a fully extended position and a fully retracted position, with a mid-stroke position between. Preferably including an external actuator that is functional to convert the motive force into linear actuation of the displacement. Preferably where the motive force is provided from manual manipulation applied externally to the seatpost assembly. Preferably including an external controller, where incremental manipulation of the controller corresponds to incremental axial displacement. Preferably including a latching mechanism to selectively restrict the axial displacement.

### CROSS-REFERENCE TO RELATED APPLICATIONS

This application claims priority of Provisional Patent Application Ser. No. 63/601,258, filed Nov. 21, 2023;

### FIELD OF THE INVENTION

The present invention relates to an improved seatpost for supporting a seating surface, particularly applicable to supporting the seat of a human powered vehicle, such as a bicycle.

### DESCRIPTION OF THE RELATED ART

Heretofore, the vast majority of bicycle seatposts have been of a rigid fixed-height configuration, where the seatpost is clamped to the frame at a given position and the height of the seat is not quickly and easily adjusted. However, more recently, height-adjustable seatposts, commonly called “dropper seatposts”, have been introduced to the market. These dropper seatposts are particularly popular in mountain bike applications where the seat must be quickly lowered or retracted to allow the rider additional clearance for riding over obstacles or steep terrain.

These dropper seatposts commonly employ two telescoping seatpost elements, comprising an inner member and an outer member, and a locking mechanism. The locking mechanism is functional to selectively lock and release the axial displacement between these two elements-preventing telescopic displacement when locked and permitting telescopic displacement when released to allow the seatpost to be telescopically adjusted to the desired height. With the locking mechanism normally locked, when the user wants to lower the seat height, he/she releases the locking mechanism and physically sits on the seat, using his/her weight to provide the motive force against the seat, pushing it down to the desired height, and thereby displacing the inner member to retract relative the outer seatpost element. This retracting displacement pushes against a mechanical or gas spring, thereby storing more energy in the spring. The user then releases and activates the locking mechanism to lock/restrict further displacement and maintain the desired seat height. Similarly, when the user wants to raise the seat height, he/she releases the locking mechanism and the stored energy in the spring serves to extend the inner member and raise the seat. During this raising, the user may use his/her buttocks to press against the seat and restrict this elevation to the desired height. The user then re-activates the locking mechanism to maintain the new seat height setting. As such, this seatpost may be considered a “passively” actuated seatpost, meaning that the user must apply motive force against the seat to retract the inner member and control the set height, rather than the height being “actively” controlled, where the seatpost assembly would otherwise act on the seat to control the seat's height.

Further, the motive force to raise the seat is provided solely by the stored energy of its return spring, which continues to provide its motive force irrespective of the height of the seat and/or of the activation of the locking mechanism. Thus, the motive force is completely divorced from the control of the seat height. In other words, the user manipulates the locking mechanism, which serves only as a switch between releasing and locking the axial displacement of the internal member. The locking mechanism does nothing to retract or extend the seatpost assembly.

Still further, the motive force provided by the spring is provided solely in the extending (i.e. raising) direction of axial displacement. The actuation and motive force provided by this spring is “dumb” in that it provides motive force and actuation that is irrespective of the position of the inner member within the range of its displacement or stroke. As a result, the spring requires that the seatpost assembly additionally includes this external locking mechanism to control the axial position of its telescopic displacement and corresponding height of the seat.

There is no provision within the seatpost and/or locking mechanism to provide motive force in the retracting direction. Motive force and actuation in the retracting direction is solely provided by the passive force applied by the user against the seat itself. This spring is housed within the seatpost itself and may be considered merely as an onboard energy storage device.

One significant shortcoming of this arrangement is that user's buttocks do not commonly have the dexterity to provide fine and precise control of the seat height. Additionally, in bicycle applications, the user is pedaling the bicycle while also adjusting the seat height, which further impairs the user's dexterity to provide fine and precise control of the seat height. In practice, the act of adjusting the seat height is quite awkward and frustrating, especially when attempting to select a seat height that is lower than the uppermost limit of the seatpost's telescopic displacement. It is even more awkward when attempting to select a seat height that is midway between the upper and lower limit of this telescopic displacement. This is further exacerbated while riding, and even further exacerbated while pedaling. In fact, users will commonly cease pedaling while attempting to adjust their seat height, thus detracting from the user's speed and control while riding.

Further, there is also no feedback to the user of the exact seat height setting or dimension. This makes it even more difficult to provide an accurate determination of the actual seat height as the user is trying to adjust it. As such, it is virtually impossible to repeatably adjust a conventional dropper seatpost to a specific seat height midway between the upper and lower limit of this telescopic displacement. The user must first sit on the seat and “test” the seat height by “feel” while riding and then attempt to further adjust as necessary. This process is clumsy and tedious and may need to be repeated multiple times to achieve the desired height, further interrupting the rider's pedaling. Furthermore, this “test” is not an accurate or absolute method of determining seat height and the user may find he/she needs further height adjustment at a later time.

An alternative to the conventional dropper post is outlined in U.S. Pat. No. 11,661,130 which relies on an electric motor to drive a lead screw to adjust the telescopic displacement and the seat height. The motor provides motive force in a rotary direction, which must include further mechanism, in the form of a lead screw assembly to translate the rotary force into the linear travel required to actuate the telescopic displacement of the seatpost assembly. The addition of the lead screw assembly adds friction and losses to the efficiency of the seatpost as well as adding weight and cost.

This arrangement also has several disadvantages. Most notably, the electric motor requires an electric power source, most likely a battery mounted to the bicycle outside the seatpost assembly. Such a battery has the undesirable fault of adding weight to the bicycle. In this application, it is also understood that such a motor will draw a significant current to deplete the battery's stored energy, which requires a larger motor and a larger battery, further adding to the weight of the bicycle. Additionally, the user commonly requires very fast and “quick” seat height adjustment, which further increases the current requirement of the motor. Still further, batteries may lose their charge, which requires diligence on the part of the user to ensure that the proper charge is always maintained. And, of course, if the battery inadvertently loses its charge, the seat height adjustment will not operate.

Japanese patent No. H0375087 describes a dropper seatpost arrangement that utilizes pressurized air, stored in an air canister that is remote from the seatpost assembly and mounted on the bicycle, to provide the energy to extend or retract the inner member. This energy is converted to motive force by a piston/cylinder arrangement onboard the seatpost assembly, which then actuates the axial displacement. This arrangement shares all of the same drawbacks associated with the spring of the conventional dropper seatpost. Additionally, this pressurized air gets depleted by adjusting the seat height, requiring the user to frequently re-charge the canister with pressurized air. Secondly, like the spring of the conventional dropper seatpost, the air canister induces its motive force irrespective of the height of the seat and/or of the activation of the locking mechanism and is completely divorced from the control of the seat height.

Both the air canister and the battery (described hereinabove) are energy storage devices that may be remote to the seatpost assembly and mounted to the bicycle to provide the raw energy to create the motive force to extend (or retract) the associated dropper seatpost. These energy storage devices are “dumb” and provide no control of the axial displacement position. Instead, an actuator within the seatpost assembly is required to translate this energy into the actuation of axial displacement of the seatpost assembly. The actuator associated with the remote air canister is a piston/cylinder arrangement where pressurized air from the canister pushes the piston. The seat height may be remotely controlled by selectively locking or unlocking the axial displacement at a given axial position. The actuator associated with the battery is an electric-motor/lead-screw arrangement where the actuator may be remotely controlled by controlling the rotation of the motor.

The result is that conventional dropper seatposts are clumsy and challenging to operate and it is also difficult, if not impossible, to adjust the seat height with accuracy and repeatability.

It is an objective of the present invention to provide a height-adjustable seatpost that is easy and efficient to operate and provides precise control of the seat height adjustment. It is a further objective of the present invention to provide accurate and repeatable control of the seat height as it is being adjusted. It is a still further objective of the present invention to provide a lightweight seatpost assembly that also does not require an external power source.

Further objects and advantages of the present invention will appear hereinbelow.

### SUMMARY OF THE INVENTION

In accordance with the present invention, it has now been found that the forgoing objects and advantages may be readily obtained.

The present invention comprises a seatpost assembly having a first portion to which a seat may be mounted and a second portion that is fixed to a frame. The first and second portions may be arranged to be displaced relative to each other in generally parallel movement to adjust the height of the seat relative to the frame between an extended and raised position of the seat and a retracted and lowered position. This parallel movement is manifest as telescopic displacement in the embodiments of the present invention described herein.

The present invention provides an active motive force to raise and/or lower the seat. This arrangement preferably includes a controller that is manually operated to adjust the seat height such that manual adjustment by the user's hands and fingers controls the height of the seat throughout its parallel travel. It is preferable that the height adjustment be performed when the user's buttocks are raised and off the seat such that there is only a minimum amount of motive force needed to raise and/or lower the seat is low. The present invention provides the option for the motive force and/or the actuation to be supplied and/or controlled remotely, preferably through manual manipulation of a remote controller assembly. This manual manipulation is preferably provided by the user. The remote control is preferably a positional remote control, wherein selective incremental control of the remote controller corresponds to a pre-selected incremental adjustment of the axial displacement of the seatpost assembly.

This arrangement provides significant advantage over conventional dropper seatposts. Firstly, control provided by manipulating the user's hands and fingers, which provides much greater dexterity than the passive control provided by the user's buttocks against the seat of conventional dropper seatposts. Secondly, control by the user's hand and fingers does not require that the user stop pedaling while controlling the height adjustment.

This manual method of axial displacement provides selective input of motive force that is directly controlled and input by the user, who may vary the motive force at will This is in contrast to conventional dropper seatpost, where the motive force is supplied by a spring or air pressure that is not varied or controlled by the user. The user can only control the output of the motive force by selectively restricting this force, through the locking mechanism and/or passively restricting the travel of the seat.

Additionally, the present invention provides “active” control of the seat height, meaning that the motive force for lowering seat height is provided by the seatpost assembly and/or the controller. In other words, the seatpost acts on the seat to lower the seat height and the user no longer needs to provide external force against the seat to provide this retracting height adjustment. This is in contrast to the “passive” control of conventional dropper seatposts where the user must press on the seat to lower its height. In other words, the seat acts on the seatpost to provide this height adjustment.

Additionally, the present invention may include a visual aid or other feedback to the user that provides indication of the current seat height. For example, the present invention may include a numerical indicator of the current controller setting, which corresponds to the current seat height. This indicator provides a visual aid, preferably within the user's field of vision while riding, that indicates the seat height setting.

Additionally, the motive force for axial displacement of the seatpost assembly may be provided by manual manipulation by the user. In contrast to the aforementioned compressed air and electric energy of a battery, such human-provided motive force is (generally) limitless and cannot be completely depleted.

Additionally, the remote controller of the present invention may be considered as a positional actuator such that positional adjustment of the controller produces a corresponding positional adjustment of the axial displacement of the seatpost assembly. This provides very accurate and repeatable control of this axial displacement. In contrast, conventional dropper seatposts provide for control of only the restriction of this axial displacement, which is a very clumsy and inaccurate control of axial displacement.

Additional features of the present invention will become apparent from considering the drawings and ensuing description.

### BRIEF DESCRIPTION OF THE DRAWINGS

The present invention will be more readily understandable from a consideration of the accompanying exemplificative drawings, wherein:

FIG. 1a is a perspective view schematically illustrating the general configuration of a height-adjustable seatpost assembly, as conventionally adapted for bicycles, including description of the generic directions and orientations utilized throughout the specification;

FIG. 1b is an orthogonal view of an alternate seatpost assembly, showing the seatpost assembly of FIG. 1 as inverted such that the internal member is axially fixed while the external member is axially displaceable relative to the internal member and axially fixed to the seat;

FIG. 1c is a cross-section view of a prior art conventional seatpost assembly, having an arrangement similar to FIG. la, with the inner member shown in the extended and raised position.

FIG. 1d is a cross-section view of the seatpost assembly of FIG. 1c, with the inner member shown in the retracted and lowered position.

FIG. 2a is a perspective view of a first embodiment of the present invention, showing the seatpost assembly as assembled;

FIG. 2b is an exploded perspective view of the embodiment of FIG. 2a, showing the basic components of the seatpost assembly;

FIG. 2c is a cross-section view of the embodiment of FIG. 2a, taken along 35-35;

FIG. 2d is a cross-section view of the embodiment of FIG. 2a, taken along 36-36;

FIG. 2e is a cross-section view of the embodiment of FIG. 2a, taken along 37-37;

FIG. 2f is a cross-section view of the internal member of the embodiment of FIG. 2a, taken along 35-35;

FIG. 2g is a cross-section view of the internal member of the embodiment of FIG. 2a, taken along 38-38;

FIG. 2h is a cross-section view of the external member of the embodiment of FIG. 2a, taken along 35-35;

FIG. 2i is a cross-section view of the external member of the embodiment of FIG. 2a, taken along 39-39;

FIG. 2j is an orthogonal view of the cam block of the embodiment of FIG. 2a;

FIG. 2k is a cross-section view of the cam block of the embodiment of FIG. 2a, taken along 40-40;

FIG. 2L is a cross-section view of the cam block of the embodiment of FIG. 2a, taken along 41-41;

FIG. 2m is a cross-section view of the control rod assembly of the embodiment of FIG. 2a, taken along 35-35;

FIGS. 2n-q are cross-section detail views of the seatpost assembly of the embodiment of FIG. 2a, taken along 35-35, showing the successive sequential steps in controlling the lowering axial advancement of the internal member with respect to the external member;

FIG. 2n shows the cam block initially in the locked position to provide axial locking between the internal and external members;

FIG. 2o shows the cam block as next advanced in the downwardly released position to release the axial locking between the internal and external members;

FIG. 2p shows the internal member as next axially advanced in the downward direction to lower the seat height to a lowered axial position;

FIG. 2q shows the cam block as next restored to the locked position to lock the lowered axial position of the internal member with respect to the external member;

FIGS. 2r-u are cross-section detail views of the seatpost assembly of the embodiment of FIG. 2a, taken along 35-35, showing the successive sequential steps in controlling the raising axial advancement of the internal member with respect to the external member;

FIG. 2r shows the cam block initially in the locked position to provide axial locking between the internal and external members;

FIG. 2s shows the cam block as next advanced in the upwardly released position to release the axial locking between the internal and external members;

FIG. 2t shows the internal member as next axially advanced in the upward direction to raise the seat height to a raised axial position;

FIG. 2u shows the cam block as next restored to the locked position to lock the raised axial position of the internal member with respect to the external member;

FIG. 2v is a cross-section view of the embodiment of FIG. 2a, taken along 35-35; showing the seatpost assembly locked in the fully raised and extended position.

FIG. 2w is a cross-section view of the embodiment of FIG. 2a, taken along 35-35; showing the seatpost assembly locked in the fully lowered and retracted position.

FIG. 2x is a cross-section view of a second embodiment of the present invention, corresponding to the view of FIG. 2v, including a spring to bias the internal member in the extending direction.

FIG. 3a is an exploded perspective view of an exemplary controller that may be utilized in conjunction with the embodiment of FIG. 2a;

FIG. 3b is a perspective view of the controller of FIG. 3a;

FIG. 3c is an orthogonal top view of the controller of FIG. 3a, shown as assembled;

FIG. 3d is a cross-section view, taken along 42-42 of the controller of FIG. 3a;

FIG. 4a is a perspective view of a second embodiment of the present invention, showing the seatpost assembly;

FIG. 4b is a perspective view of an exemplary controller that may be utilized in conjunction with the embodiment of FIG. 4a;

FIG. 4c is a perspective view of the screw shaft of the controller of FIG. 4b;

FIG. 4d is a cross-sectional view, taken along 43-43, of the seatpost assembly of FIG. 4a, showing the seatpost assembly in the fully lowered and retracted position.

FIG. 4e is a cross-sectional view, taken along 174-174, of the seatpost assembly of FIG. 4d.

FIG. 4f is a cross-sectional view, taken along 44-44, of the controller of FIG. 4b, showing the controller and screw shaft as adjusted corresponding to the position of seatpost assembly shown in FIG. 4d.

FIG. 4g is a cross-sectional view, taken along 43-43, of the seatpost assembly of FIG. 4a, showing the seatpost assembly in the fully raised and extended position.

FIG. 4h is a cross-sectional view, taken along 44-44, of the controller of FIG. 4b, showing the controller and screw shaft as adjusted corresponding to the position of seatpost assembly shown in FIG. 4f.

FIG. 4i is an exploded cross-sectional exploded view, taken along 43-43, of the seatpost assembly of FIG. 4a.

FIG. 4j is an exploded cross-sectional view, taken along 44-44, of the controller of FIG. 4b.

### DETAILED DESCRIPTION OF THE INVENTION

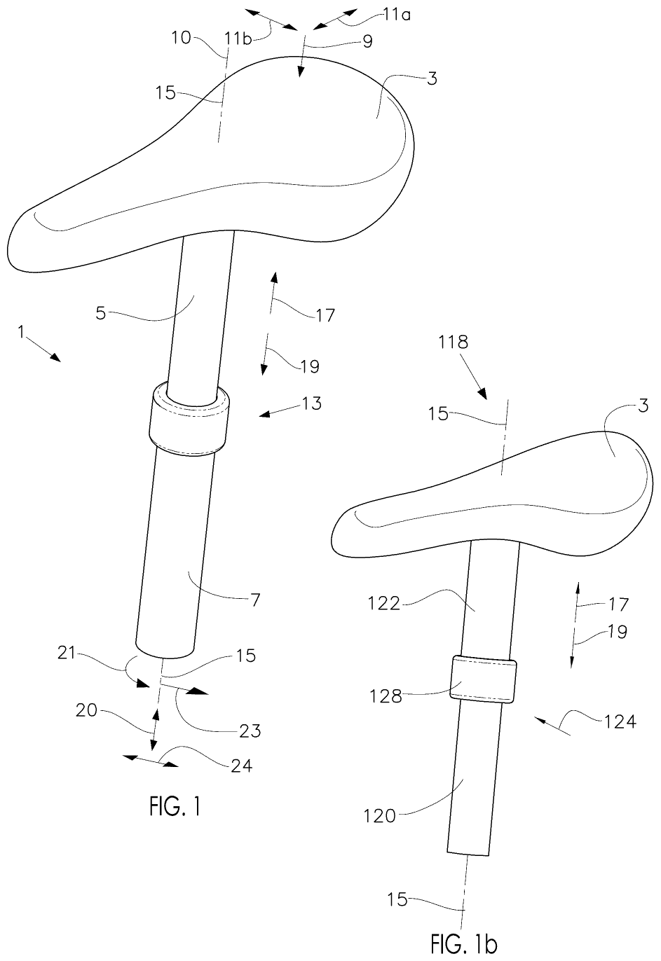

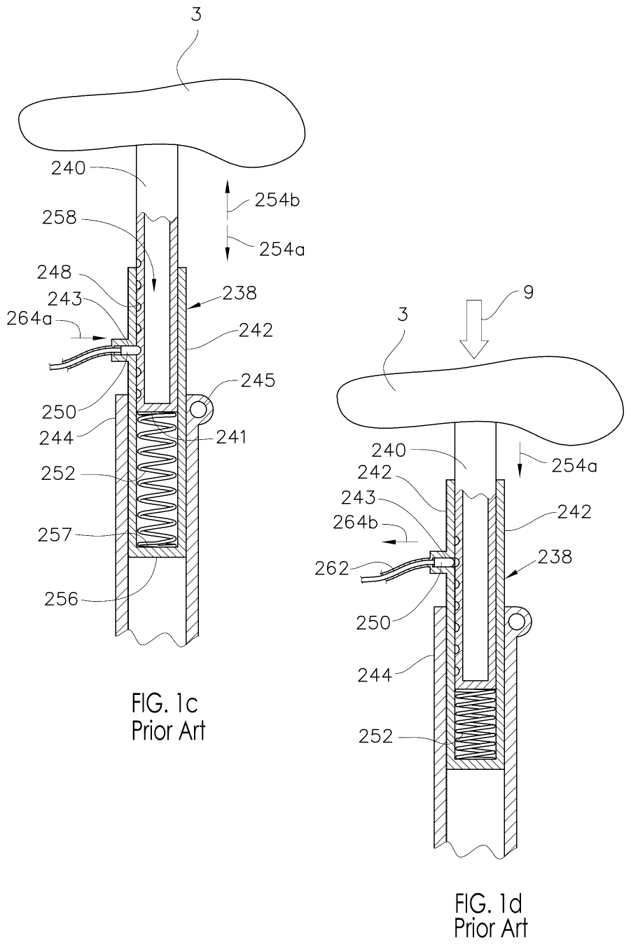

FIG. 1 describes the basic configuration of an exemplary height adjustable seatpost as adapted to a bicycle seat, as well as a description of the direction conventions used throughout this disclosure. For clarity, the corresponding bicycle frame is not shown in this figure.

The seatpost axis 10 extends along the general centerline of the seatpost assembly 1. The Seatpost assembly 1 consists of an internal member 5 that is telescopically guided within an external member 7 along an axial axis 15. Internal member 5 is adapted for mounting of a seat 3 in the conventional manner. The external member 7 is commonly fixedly mounted to the frame of a bicycle (not shown). The internal member 5 is moveable and may be telescopically displaced along axial axis 15 relative to the external member 7 to be generally upwardly raised and extended relative in the extending direction 17 and generally downwardly lowered and retracted in the retracting direction 19. The extending direction 17 and retracting direction 19 are both generally parallel to the axial axis 15. The extended orientation corresponds to reduced axial overlap between the internal member 5 and external member 7 while the retracted orientation corresponds to an increase in such axial overlap. The internal member 5 commonly has a maximum axial displacement or stroke relative to the external member 7 between a fully extended positional limit or end-stop and a fully retracted positional limit or end-stop. A mid-stroke position is a position between the fully extended limit and the fully retracted limit. The seatpost axis 10 and the axial axis 15 are generally collinear and may be used interchangeably throughout this disclosure except where noted. The seat 3 serves to generally support the weight of the rider, which corresponds to an axial load 9 applied to the seat 3. While the majority of load applied to the seat 3 by the rider is axial load 9, normal use also serves to induce lateral loads 11a and 11b to the seat as well, which may impart a significant bending moment to the seatpost assembly 1.

In order to withstand these lateral loads 11a and 11b, the seatpost assembly 1 must have sufficient structural strength and stiffness to support these loads. This is achieved through the robust telescopic guiding and circumferential keying between the internal member 5 and external member 7. This also requires that the internal member 5 and external member 7 have adequate strength and stiffness.

It is noted that the seat 3 is directly connected to the internal member 5. The seatpost assembly 1 preferably includes telescopic guiding and circumferential keying between the internal member 5 and external member 7. As such, there is preferably no necessity for any additional linkage or movable element that connects the internal member 5 to the frame (not shown) for this guiding or keying. This further supports the requirement that the seatpost assembly 1 be a structural assembly to support axial loads 9 as well as lateral loads 11a and 11b.

The axial direction 20 is a direction along the axial axis 15. An axially raised orientation corresponds to the raised (or higher or elevated) orientation of the seat 3 while an axially lowered orientation corresponds to the lowered orientation of the seat 3. The radial direction 23 is a direction generally perpendicular to the seatpost axis 10 and extends generally from the seatpost axis 10 radially outwardly. A radially inward orientation is proximal the seatpost axis 10 and a radially outward orientation is distal the seatpost axis 10. The circumferential direction 21 is a cylindrical vector that wraps around the seatpost axis 10 at a given radius. A downward or lower orientation is an orientation along the seatpost axis 10 that is proximal to the fixed member (shown here as the external member 7) and to the frame (not shown). Conversely, an elevated, upward, upper or raised orientation is axially opposed to the downward orientation and proximal the seat 3 (and distal to the fixed member and to the frame). A lateral direction 24 is a direction along a plane generally perpendicular to the axial axis 15, with a laterally inwardly orientation is an orientation proximal the axial axis 15 and a laterally outward orientation is an orientation distal the axial axis 15. The terms “axial displacement” and “axial position”, when referring to the seatpost assembly 1, correspond to the respective displacement and position of the internal member 5 (i.e. movable seatpost portion) relative to the external member 7 (i.e. fixed seatpost portion). In the case of a dropper seatpost, it may be considered that the term “motive force” refers to a force input (regardless of direction) to the seatpost assembly 48 that drives the axial displacement. The term “actuator” is the apparatus that converts the motive force into the axial displacement.

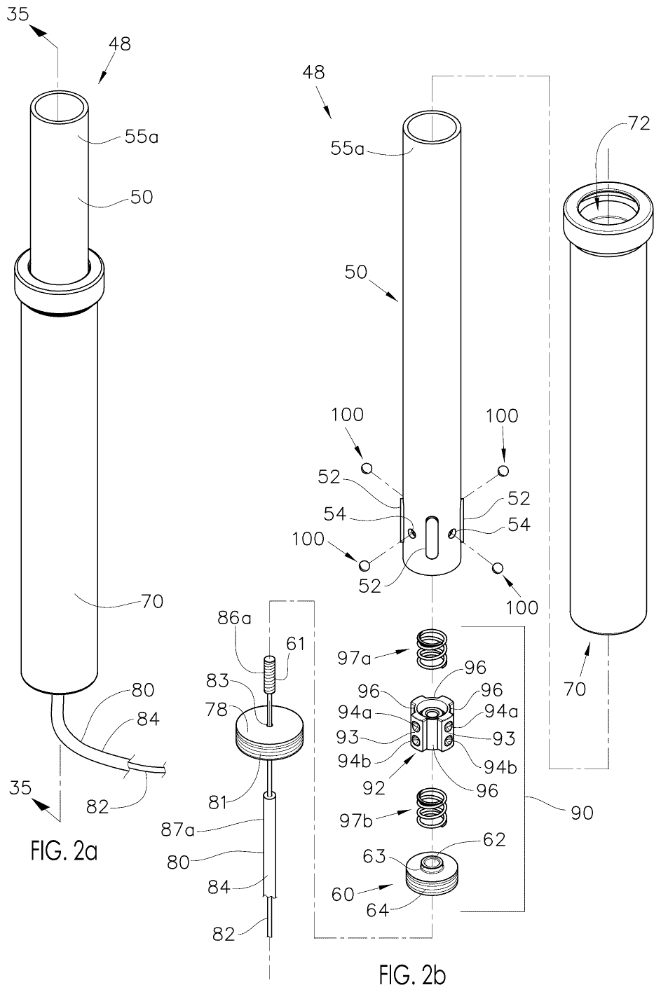

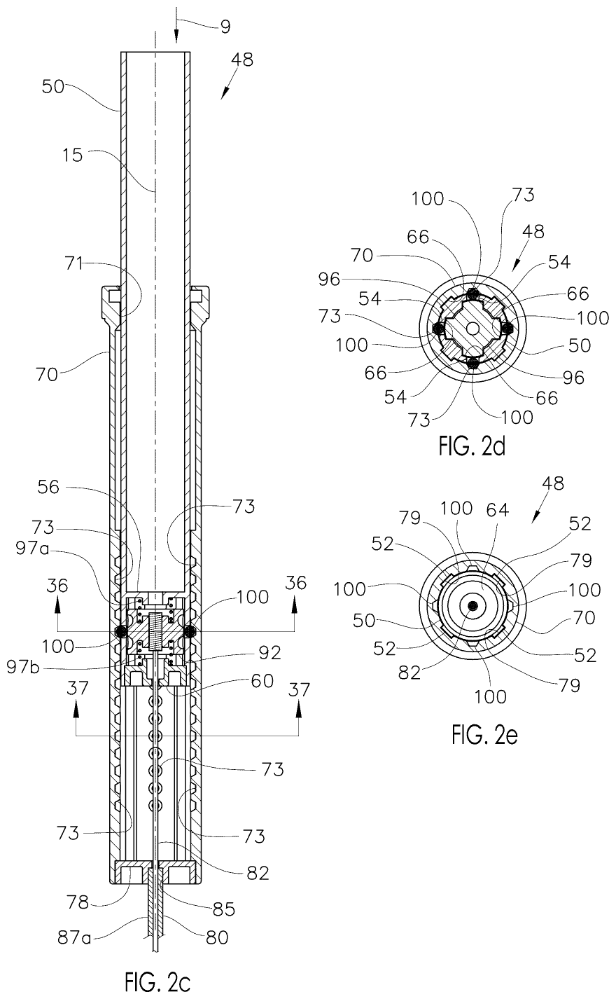

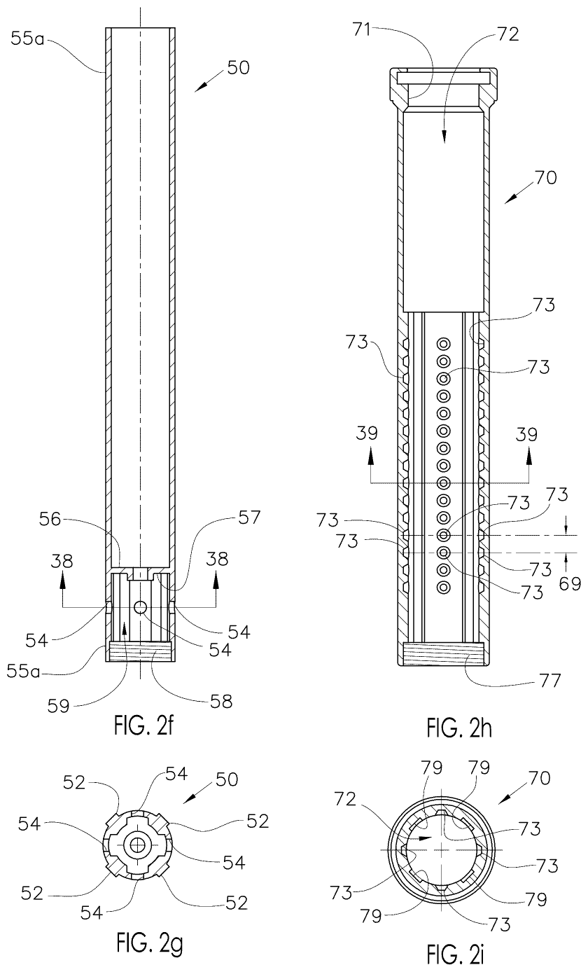

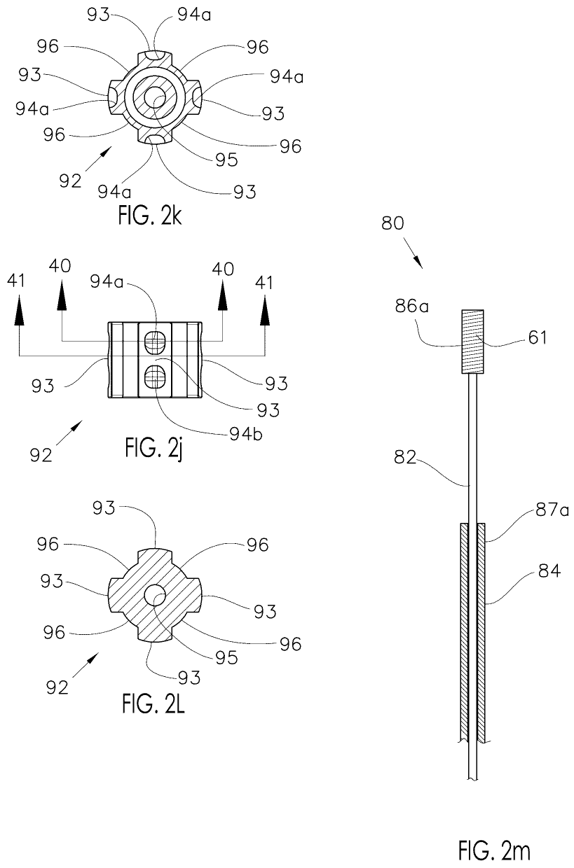

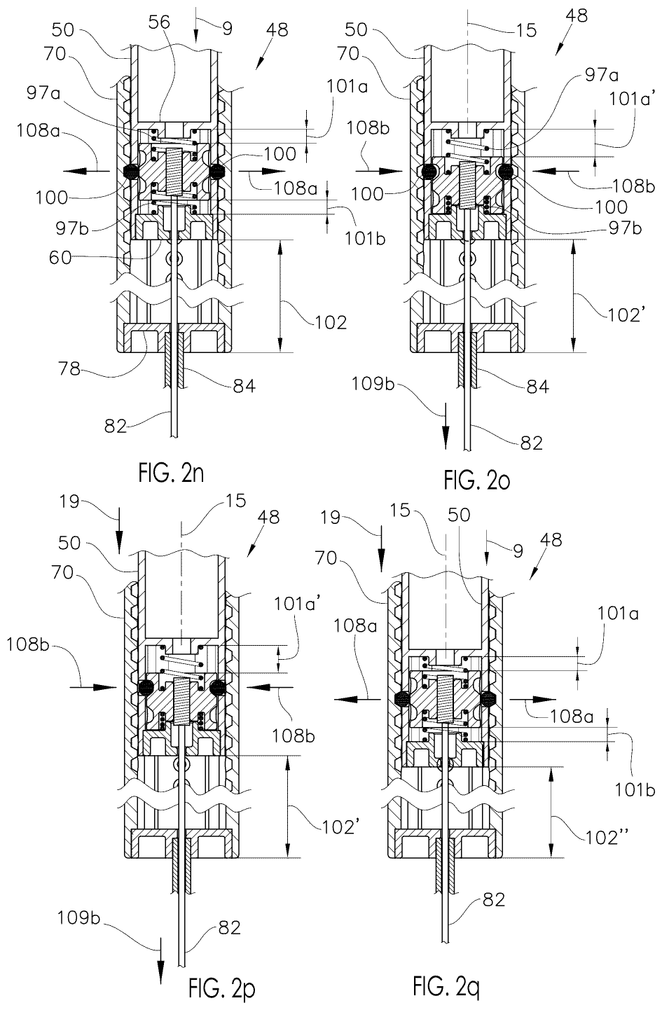

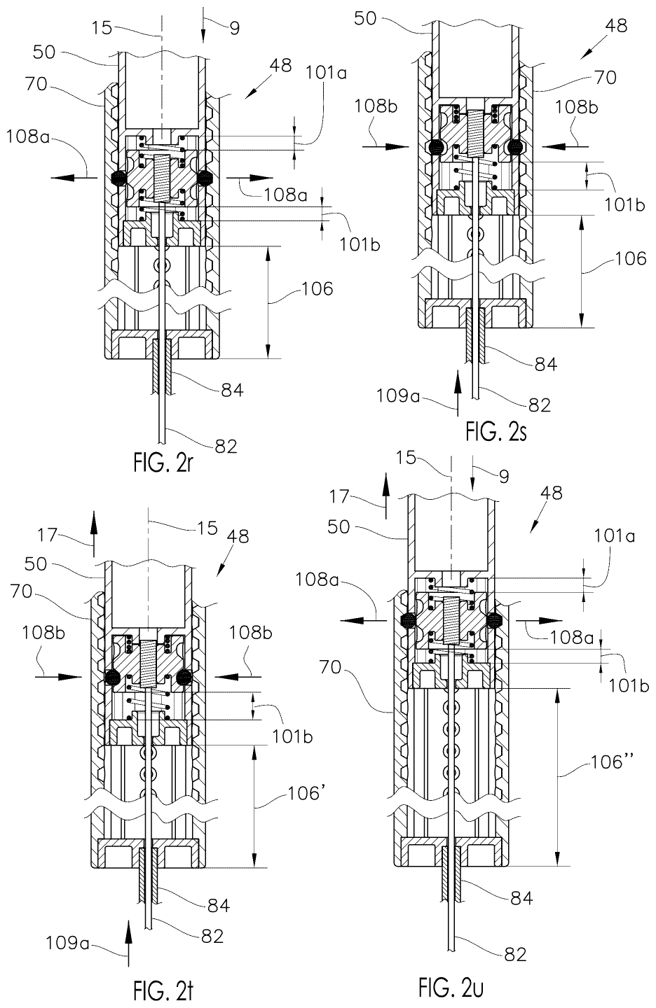

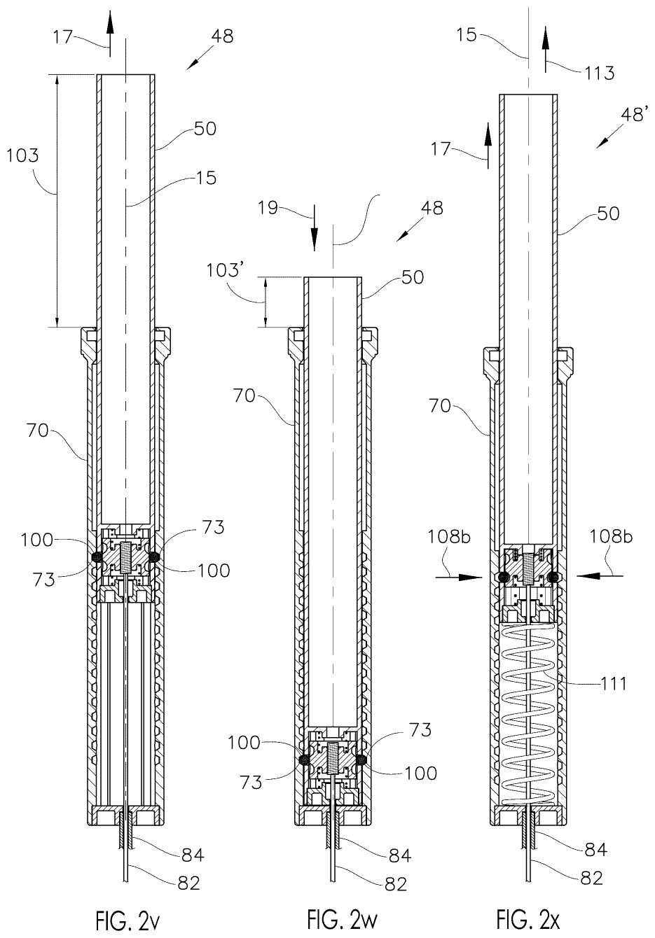

The arrangement described in FIG. la corresponds to the arrangement described in FIGS. 2a-w, however the generic terms and schematic arrangement described in FIG. la may also generically correspond to any of the figures herein. It is understood that these generic terms may also be applied to a wide range of alternate configurations. In one such alternate example, the seatpost assembly 124 may in an upside-down configuration, as shown in FIG. 1b, where the internal member 120 may be positioned below the external member 122 and may be fixed to the frame (not shown), with the external member 122 fixed to the seat 3 and telescopically displaceable in directions 17 and 19 relative to the internal member 120.

While FIG. 1a describes a seatpost assembly 1 where the external member 7 is axially fixed to the frame (not shown) and the internal member 5 as axially displaceable relative to the internal member 5 and fixed to the seat 3. The axial displacement thus serves to selectively adjust the height of the seat 3. However, this is but one possible arrangement. FIG. 1b shows an alternate arrangement whereby the arrangement of FIG. 1a is transposed to provide an upside-down seatpost assembly 118 with an internal member 120 that is axially fixed to the frame (not shown) and an external member 122 that is axially displaceable relative to the internal member 120 and fixed to the seat 3. This axial displacement also serves to selectively adjust the height of the seat 3.

While the internal member 5 and external member 7 are shown here to be generally linear elements that extend longitudinally along a generally straight axial axis 15, it is envisioned that, in a second alternate configuration, the telescopic or axial axis 15 need not necessarily be straight and longitudinal. For example, the internal and external members may alternatively be arcuate elements, with the internal member displaceable relative to the external member along an arcuate axial axis.

FIGS. 1a-b shows the external member 7 and internal member 120 to each be formed as a separate element that is fixedly connected to the frame of a bicycle (not shown). It is envisioned that external member 7 and internal member 120 may each be formed as a portion of the frame itself, thus eliminating the aforementioned connection.

FIGS. 1c-d describe, in schematic form, a prior art conventional dropper seatpost. Seatpost assembly 238 includes an external member 242, an internal member 240 telescopically guided within external member 242, a spring 252 in the form of a compression spring, and a peg 250 that is remotely operable to engage and disengage from a series of sockets 248 in the internal member. External member 242 includes axially extending opening 243 and is closed at its lower end 256 to include end face 257. External member includes an opening 258 for passage of peg 250 therethrough. External member is also secured to the seat tube 244 of a bicycle frame in the conventional manner by tightening pinch bolt 245. Internal member 240 includes a series of axially spaced sockets 248 sized to receive peg 259 and is adapted to secure the seat 3 in the conventional manner. Spring 252 is braced between the bottom end 241 of the internal member 240 and the end face 257 as shown.

Peg 250 is guided within opening 258 such that it may be laterally shuttled in directions 264a and 264b therein, in directions 264a and 264b, to be actuated between an engaged orientation where the peg 250 is laterally inwardly positioned to engage with a selected socket 248 and a disengaged orientation where the peg 250 is laterally outwardly withdrawn to disengage with the selected socket 248. It is preferred that the peg 248 may be remotely actuated by a remote lever (not shown) that controls the lateral position of the peg 250 through a cable and sheath as is commonly utilized.

FIG. 1c shows the seatpost assembly in the raised and extended orientation where the peg 250 is shuttled in direction 264a to an engaged orientation and to be engaged to a lower one of the sockets 248, which serves to lock the position of the internal member 240 in this raised and extended orientation. If the user elects to lower the seat, he/she operates the remote lever to move the peg 250 to the disengaged orientation, freeing the internal member to be retracted. The user then sits on seat 3 to apply axial load 9 against the seat 3 with their buttocks to telescopically displace the internal member 240 in the downward direction 254a, retracting the internal member 240 and compressing spring 252 until an upper one of the sockets 248 is aligned with opening 258. The user then operates the lever to move the peg 250 back to the engaged orientation, which serves to lock the position of the internal member 240 in this newly lowered and retracted orientation of the seatpost assembly 238. The telescopic displacement of the seatpost assembly 238 and corresponding height of the seat 3 may be subsequently raised and extended by operating the peg 240 as described above. However, when raising and extending the internal member 240 in direction 254b, the user will commonly reduce the force 251 against the seat and allow the stored energy of the spring 252 to push the internal member 240 in direction 254b and then increase pressure against the seat 3, while the peg 250 is in the disengaged orientation, in an attempt to restrain the axial displacement of internal member 240 at a desired extended and raised position. The user then manipulates the peg 250 to the engaged orientation.

The seatpost assembly 238 is shown here as a greatly simplified and schematic arrangement provided for illustration purposes. Modern conventional dropper seatposts are commonly more sophisticated and utilize an air spring in place of the wire compression spring 252 and pneumatic or hydraulic valving for locking in place of the peg 250 and socket 248 engagement, among other refinements. FIGS. 1a-b clearly describes how the user must press against the seat 3 to provide the motive force 251 to passively displace the seatpost assembly 238 in the retracting direction 254a, and must also passively press against the seat 3 to modulate and control the axial displacement of the seatpost assembly 238 in the extending direction 254b. The motive force in the extending direction is provided by the energy of the spring 252, however the spring is “dumb” in that it continues to provide motive force regardless of the axial position of the internal member 240 relative to the external member 242. As such, the modulating the force of the user's buttocks against the seat 3 is required to control the degree and position of axial displacement of the seatpost assembly 238 during seat height adjustment. The user's buttocks have limited dexterity in this capacity and it is difficult, if not impossible, to precisely control the seat height when axially displacing the seatpost assembly 238 to a mid-stroke position. Since the remote lever only controls the engagement/release of the peg 250, it cannot provide any feedback to the user as to the seat height. Instead, the user must gauge seat height by “feel” through his/her buttocks and leg extension, which is certainly a very unreliable means of feedback.

FIGS. 2a-w describe a first embodiment of a seatpost assembly 48, including an internal member 50, an external member 70, a control rod assembly 80, a cam assembly 90, and balls 100. Although not detailed, the internal member 50 is adapted for mounting of a seat 3 (not shown) adjacent its first end 55a in the conventional manner.

Cam assembly 90 includes cam block 92 that is axially sandwiched between springs 97a and 97b. Cam block includes: four upper recesses 94a and four lower recesses 94b axially spaced therefrom and having a blocking surface 93 axially located therebetween. Each pair of axially aligned recesses 94a and 94b are circumferentially spaced about the axial axis 15 as shown; axially extending channels 96, with each channel 96 circumferentially positioned between adjacent recess 94a and 94b pairs; and a receiver 95 in the form of an internal threaded hole 95 to receive the mating external threads 61 of the connector 86a.

External member 70 includes: opening 72 to receive internal member 50; bushing 71 for guiding of internal member 50; four circumferentially spaced columns of sockets 73; axially extending grooves 79, with each channel 96 circumferentially positioned between adjacent columns of sockets 73; and internal threads 77. Individual sockets 73 of each column are preferably spaced at an even axial interval such that the individual sockets 73 of adjacent columns are axially coincident as shown. Sockets 73 are shown to be frustoconical in shape, although they may be straight cylindrical or may simply be comprised of individual circumferential grooves or other radially outwardly recessed geometry. Cap 78 includes external threads 81 to threadably mate with internal threads 77; and hole 83 providing clearance for passage of rod 82, with counterbore 85 to receive the end portion 87a of sheath 84.

Internal member 50 is a generally cylindrical element that includes four circumferentially spaced keys 52 that are aligned to slide within grooves 79 to provide a guided and axially slidable bushing engagement between the internal member 50 and external member 70 and also to limit and prevent rotation between the internal member 50 and external member 70 to maintain circumferential alignment therebetween as the internal member 50 is extended and retracted. It is preferred that the internal member 50 be of a lightweight high strength material such as aluminum or fiber-reinforced composite and that the keys be made of rigid lubricious material such as nylon or acetal polymer. Internal member 50 also includes: four circumferentially spaced and axially coincident holes 54 sized to receive balls 100; internal wall 56 having bearing surface 57 to brace against spring 97a; opening 59 to receive the cam assembly 90; axially extending grooves 66, with each groove 66 circumferentially positioned in alignment with a corresponding hole 54; and internal threads 77. Cap 60 includes a pilot collar 63 for radial piloting of spring 97b; hole 62 to provide clearance for passage of rod 82; and external threads 64 to threadably mate with internal threads 77.

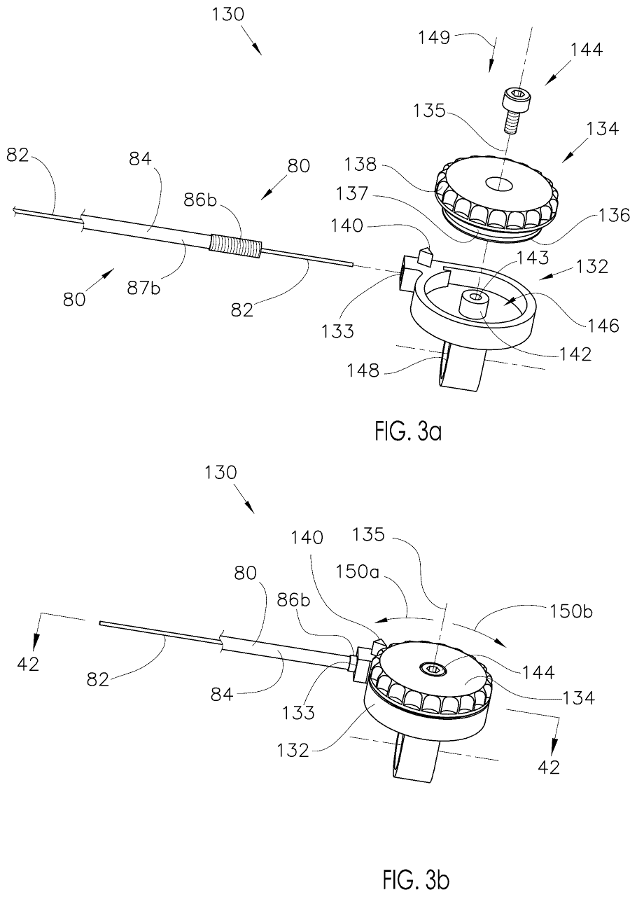

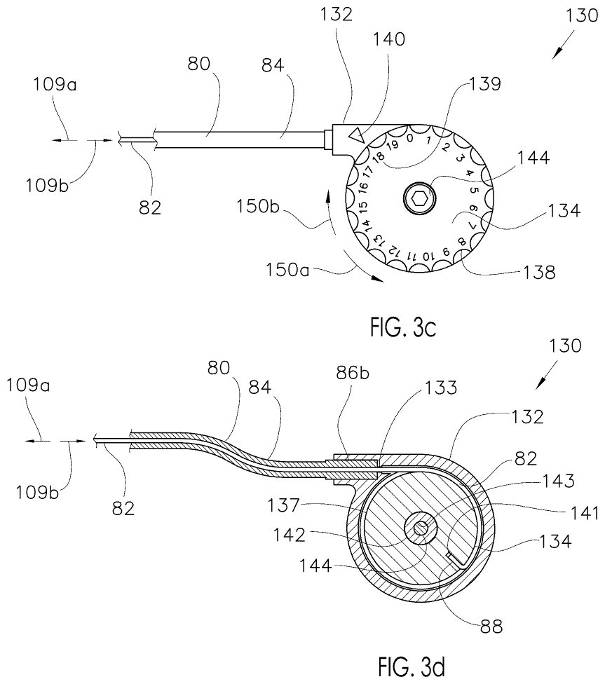

Control rod assembly 80 is of conventional configuration and includes a linear rod 82 guided within a housing or sheath 84. The rod 82 includes a connector 86a at the end proximal the cam block 92 and a bent portion 88 (see FIG. 3d) at the end proximal the controller assembly 130 (see FIGS. 3a-d). Connector 86a includes external threads 61 for threadable assembly with the internal threads of receiver 95.

These components are assembled as particularly shown in FIG. 2c to create seatpost assembly 48. Connector 86a is threadably connected to the receiver 95 of cam block 92. Cap 60 is assembled to internal member 50, with threads 64 threadably engaged to threads 58 to capture the spring 97a, cam block 92 and spring 97b as shown. Spring 97a is a compression spring and is braced between the bearing surface 57 and the cam block 92. Spring 97b is also a compression spring and is braced between the cam block 92 and the cap 60. Channels 96 are aligned to be axially guided with grooves 66 such that recesses 94a and 94b are also circumferentially aligned with holes 54. The internal member 50 is sleevably assembled with the external member 70 as shown, including balls 100 positioned within corresponding holes 54, such that keys 52 are axially guided within respective mating grooves 79. Cap 78 is assembled to external member 70, with threads 81 threadably engaged to threads 77 to capture the internal member 50 within the opening 72 of external member 70.

Balls 100 are positioned within holes 54 and radially bounded between the external member 70 and cam block 92. Recesses 94a and 94b are radially inboard surfaces to receive balls 100, while blocking surfaces 93 are radially outboard of recesses 94, such that axial displacement of the cam block 92 serves to cam and radially displace the balls 100 within holes 54 between a radially inboard position when recesses 94 are axially aligned with holes 54 and a radially outboard position when blocking surfaces 93 are axially aligned with holes 54. Springs 97a and 97b serve to axially bias the cam block 92 toward the radially outboard position where blocking surfaces 93 are axially aligned with holes 54.

As shown in FIGS. 2c-d, balls 100 are axially aligned with respective blocking surfaces 93 such that the balls 100 serve as a key span between holes 54 and sockets 73 to axially lock the internal member 50 and external member 70 to support axial load 9, which corresponds to the seating load of the rider (not shown).

FIGS. 2n-q details the sequence where the control rod 82 is used to displace the internal member 50 in the retracting direction 19 from a first axial position to a second and lower axial position. As shown in FIG. 2n, which corresponds to FIG. 2c, the control rod 82 has not yet been displaced and the cam assembly 90 is in its “home position” where the springs 97a and 97b are balanced such that dimensions 101a and 101b are equal and the axial position of the cam block 92 relative the internal member 50 is maintained by springs 97a and 97b such that the blocking surfaces 93 are axially aligned and overlapping their respective holes 54. This serves to push balls 100 in the radially outward direction 108a to a radial outward position, with blocking surfaces 93 axially aligned with balls 100 as shown in FIG. 2n. Blocking surface 93 serve to maintain this radial outward position such that balls 100 radially overlap both the holes 54 and the mating sockets 73. As such, balls 100 span and bridge between the internal member 50 and external member 70, thus engaging, latching, and locking the axial position of these two members (50 and 70) together and maintaining the corresponding seat height and supporting axial load 9. Blocking surfaces 93 serve to block balls 100 from moving radially inward, thus maintaining this locked engagement. This is considered the “locked” or “latched” orientation of the cam assembly 90. A seat (not shown) connected to the internal member 50 can support axial load 9.

Next, the control rod 82 is linearly shuttled and displaced within sheath 84 in direction 109b as shown in 20, which serves to compress spring 97b and axially displace the cam block 92 in direction 109b relative to the internal member 50, reducing dimension 101b (and correspondingly increase dimension 101a) until recesses 94a are axially aligned with their respective holes 54. This initial displacement removes the blocking engagement of FIG. 2n and permits the balls 100 to move radially inwardly in direction 108b until the balls 100 are no longer radially overlapping sockets 73 as shown in FIG. 20. This removes the locking bridge between the internal member 50 and external member 70 and is considered the “downwardly released” orientation of the cam assembly 90. This initial displacement of the cam block 92 is considered to be “lost motion” of the control rod 82 because this displacement serves only to release the locking bridge and does not (yet) serve to advance the internal member 50 in direction 109b.

Further displacement of the control rod 82 in direction 109b serves to provide motive force to actively pull and axially displace the internal member 50 in retracting direction 19. Selective displacement of the control rod 82 in direction 109b serves to correspondingly actively retract the internal member 50 until a new targeted lowered seat height is achieved as shown in FIG, 2p. The axial position of the control rod 82 relative to the external member 70 is then maintained such that springs 97a and 97b serve to bias the cam block 92 in direction 109a back toward the latched home position, biasing and pushing the balls 100 radially outwardly out of their recesses 94a until they engage and radially overlap a new set of sockets 73 that correspond to the newly selected and lowered seat height. The balls 100 again provide a locking bridge between the internal member 50 and external member, and the cam assembly 90 is again in the home and locked position described in FIG. 2n and shown in FIG. 2q. The cam assembly 90 is now latched and locked in an axial position associated with the socket 73 to which the balls 100 are engaged. The internal member 50 may again support axial load 9.

The cam assembly 90, holes 54, balls 100, and sockets 73 may be considered to be a latching mechanism, serving to latch and unlatch the axial displacement of the internal member 50 relative to the external member 70 as described herein. It may be seen that the internal member 50 may be axially displaced in discrete increments corresponding to the axial distance 69 between axially adjacent sockets 73 and/or may be axially advanced to bypass the axial position associated with a given socket(s). This latching mechanism has an input end, where motive force and actuation is input from the rod 82 to the cam block 92 of the latching assembly, and an output end, where the motive force and actuation is transmitted from the cam block 92 and spring 97a to the internal member 50. The aforementioned “lost motion” occurs between the input end and output end.

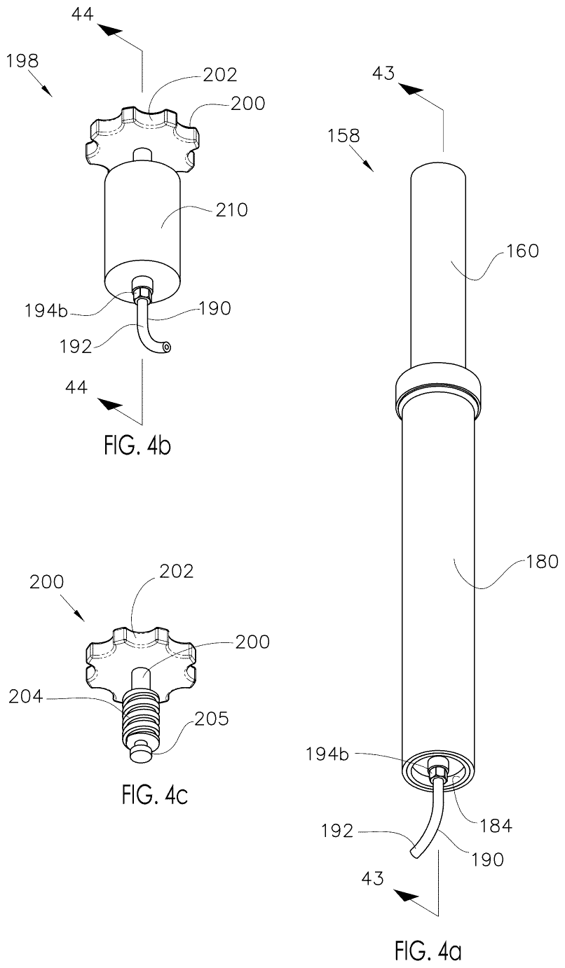

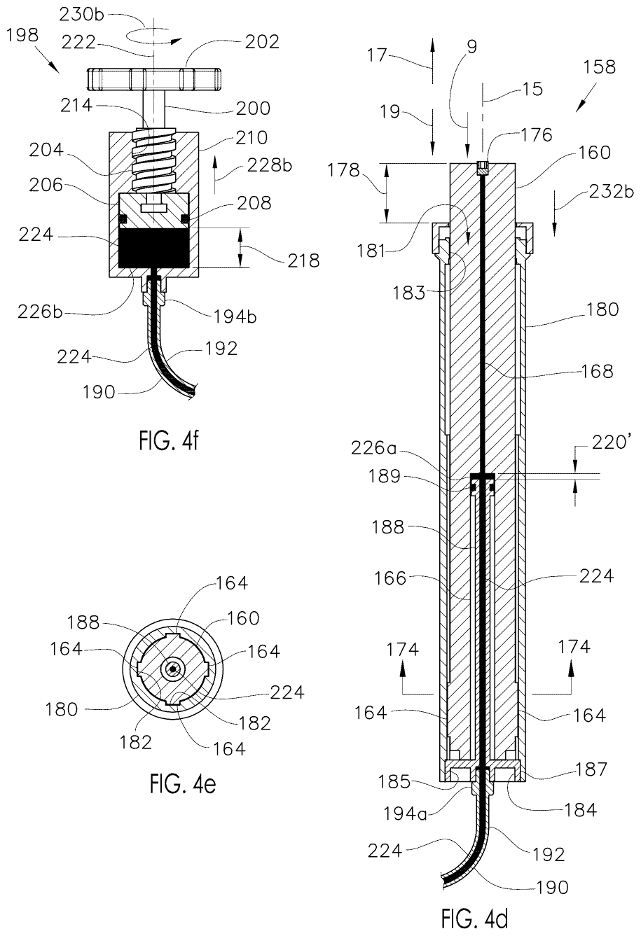

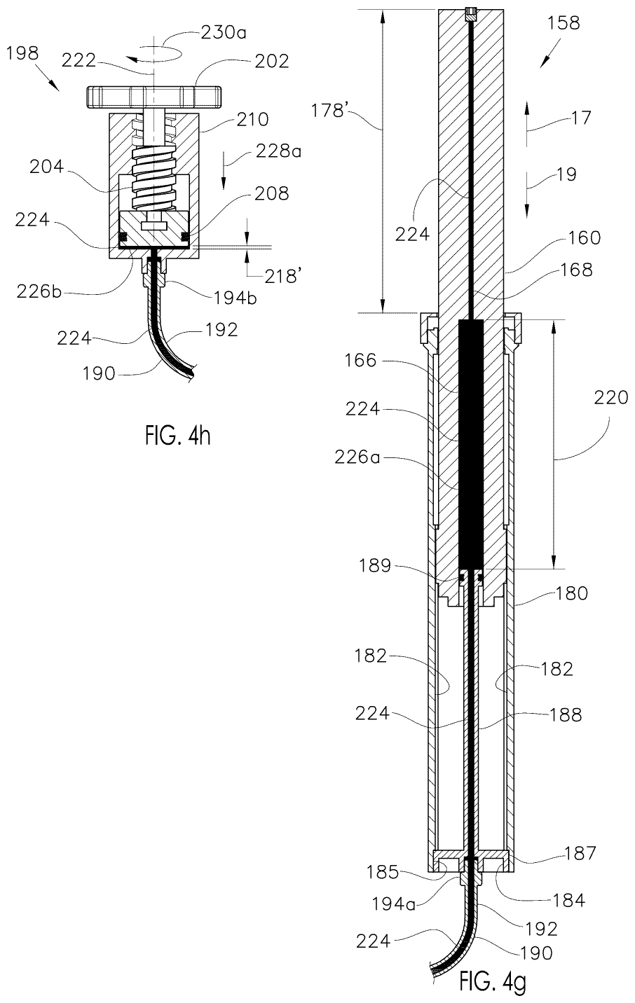

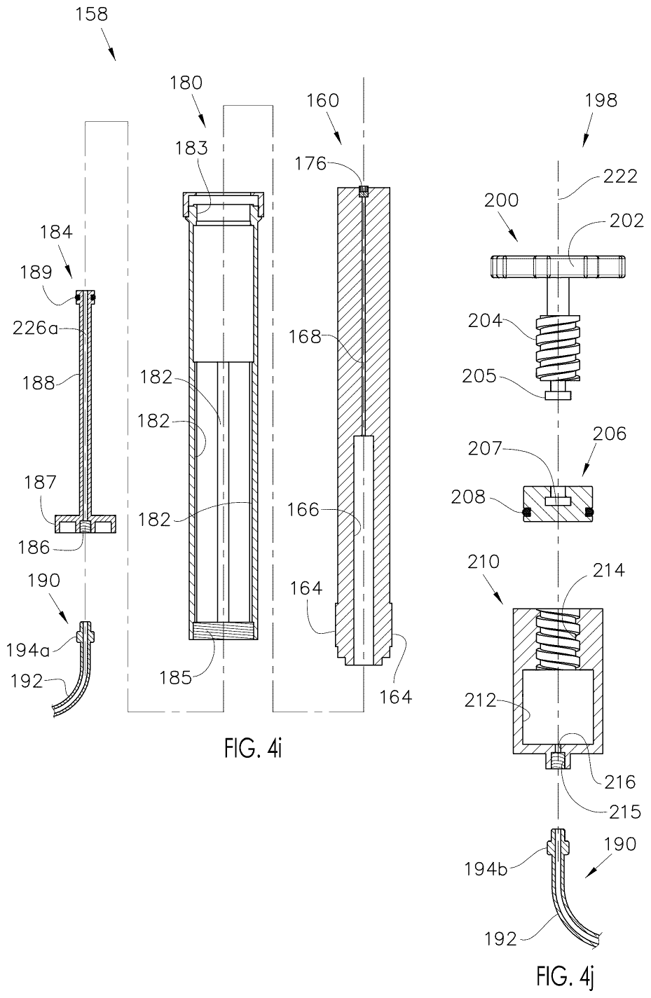

A latching mechanism is defined herein as a mechanism or system that is functional to selectively: (i) latch and restrain the telescopic displacement of the internal member relative to the external member; and to (ii) unlatch and release this restraint to permit this displacement. It is preferable that this latching and un-latching may be selectively controlled as shown in the embodiment of FIGS. 2a-w. The latching mechanism may provide this latching through mechanical engagement between the inner and outer members, as described in FIGS. 2a-x, and/or by restricting hydraulic fluid flow as described in FIGS. 4a-j, and or by another restraining means such as magnetic restraint among others.

It may be preferable that the motive force applied at the input end of the latching mechanism be greater or lesser than the motive force transmitted at the output end. It may alternatively be preferable that the latching mechanism include further features to provide a self-energizing function, where passive downward force applied to the seat 3 may serve to augment the latching of the latching mechanism.

It is noted that the control rod assembly 80 is braced between the cam block 92 and the cap 60 that is below the cam block 92 such that the rod 82 is pulling (i.e. in tension) the internal member 50 downward when axially displaced in the retracting direction 19. By pulling the rod, the rod 82 cannot buckle. This is in contrast to prior art dropper seatposts, where active displacement is commonly actuated in a pushing direction to push (in compression) against an associated internal member.

FIGS. 2r-u detail the sequence where the control rod 82 is used to displace the internal member 50 in the extending direction 17 from a first axial position to a second and raised axial position. As shown in FIG. 2r, the control rod 82 has not yet been displaced and the cam assembly 90 is in its “home position” as described in FIG. 2n. Next, the control rod 82 is linearly shuttled and displaced within sheath 84 in direction 109a as shown in 2s, which serves to compress spring 97a and axially displace the cam block 92 in direction 109a relative to the internal member 50, reducing dimension 101a (and correspondingly increase dimension 101b) until recesses 94b are axially aligned with their respective holes 54. This removes the blocking engagement of FIG. 2r and permits the balls 100 to move radially inward in direction 108b until the balls 100 are no longer positioned within sockets 73 as shown in FIG. 2s. This removes the locking bridge between the internal member 50 and external member 70 and is considered the “upwardly released” orientation of the cam assembly 90. Again, this initial displacement of the cam block 92 is considered to be “lost motion” of the control rod.

Further displacement of the control rod 82 in direction 109a serves to provide motive force to actively push and displace the internal member 50 in the extending direction 17. Selective displacement of the control rod 82 in direction 109a serves to correspondingly actively extend the internal member 50 until a new raised seat height is achieved as shown in FIG, 2t. The axial position of the control rod 82 is then selectively released at this desired target position and the springs 97a and 97b serve to bias the cam block 92 back toward the home position, biasing and pushing the balls 100 radially outwardly out of their recesses 94a until they engage and radially overlap a new set of sockets 73 that correspond to the newly selected and raised seat height. The balls 100 again provide a locking bridge between the internal member 50 and external member and the cam assembly 90 is again in the latched home position described in FIG. 2n and shown in FIG. 2u. Internal member 50 has thus now been axially retracted and locked in a lowered mid-stroke position relative to the external member 70.

FIG. 2v shows the seatpost assembly 48 as raised to the fully extended orientation, where the internal member 50 is axially displaced to protrude from the external member by dimension 103. The balls 100 are shown to be mated and engaged to the uppermost sockets 73, which corresponds to the upper limit of extension of the internal member 50. Conversely, FIG. 2w shows the seatpost assembly 48 as lowered to the fully retracted orientation, where the internal member 50 is protruding from the external member by dimension 103′, which is smaller than dimension 103. The balls 100 are shown to be mated and engaged to the lowest sockets 73, which corresponds to the lower limit of retraction of the internal member 50.

The operation and function of the embodiment of FIGS. 2a-w and 3a-d provides a significant departure from prior art seatpost assemblies. Firstly, it is noted that the linear shuttling of the rod 82 within the sheath 84, and correspondingly the linear shuttling of the cam block 92, serve to provide active motive force to actuate the axial displacement of the internal member 50 in directions 17 and/or 19. This is in contrast to the rotary motive force of U.S. Pat. No. 11,661,130, which relies on the rotation of an electric motor for motive force.

Secondly, the linear shuttling of the rod 82 provides an active input and motive force to the seatpost assembly 48 to both advance and control displacement of the internal member 50 in directions 17 and/or 19. In other words, the present invention serves to “actively” control the displacement of the internal member 50 and correspondingly raise and/or lower the seat (not shown). This “active” input is in contrast to the “passive” input of conventional seatpost assemblies 238, where the user must apply motive force 251 against the seat (and internal member 240 fixed thereto) in order to displace the internal member 240 in the retracting direction 254a. Similarly, the user must apply passive force 251 against the seat 3 to control the axial displacement of the seatpost assembly 238 when the internal member is displaced in the extending direction 254b. In other words, prior art seatpost assemblies require force against the seat to “passively” provide motive force and “passively” control the displacement of its internal member and correspondingly raise and/or lower its seat.

Thirdly, the present invention may provide for remote actuation and control of the seatpost assembly 48, where a controller assembly 130 that is remote from the seatpost assembly 48 may be manipulated to selectively control the axial displacement of the internal member 50 in directions 17 and/or 19. The controller assembly 130 may also be manually manipulated by the user to provide a remote source of motive force to extend and/or retract the seatpost assembly 48. In contrast, prior art seatpost assemblies may sometimes provide a remote lever that serves merely to selectively release a locking mechanism (258, 250, 248) within its seatpost assembly 238 to allow its internal member 240 to be axially displaced. This control lever does nothing to actuate or provide motive force to selectively control the height of the seat.

Fourthly, prior art seatpost assemblies require some degree of stored energy within the seatpost assembly itself in order to provide motive force to displace its internal member in the extending direction. This stored energy is commonly provided by a mechanical spring or gas spring, which can only provide motive force in one direction. Motive force in the opposite direction must be provided from another source, which may be compressed air or electricity stored in a battery, etc. These other sources are expendable and depleted through repeated actuation of their motive force, meaning that these sources must be regularly recharged to function. In contrast, the present invention, while it may include some stored energy, this is not a requirement and the present invention may provide such motive force through manual manipulation by the user. Such motive force lasts the life of the user and is not depleted.

It is preferred that the user take their weight off of the seat during raising and lowering of the seat height as described in the sequences described in FIGS. 2r-u and 2n-q. This reduced the motive force required to displace the control rod 82 in directions 17 and 19 and also minimizes “push-back” in direction 19 where the user's weight would otherwise push against the control rod 82 during the upwardly-released and/or downwardly-released orientations of the cam assembly 90.

FIG. 2x describes an embodiment identical to that of FIGS. 2a-w, with the exception that a compression spring 111 is incorporated into the seatpost assembly 48′. The spring 111 is braced between the caps 78 and 60 and serves to bias the internal member 50, by bias force 113, in the extending direction 17 relative to the external member 70. Bias force 113 may be helpful to counterbalance the weight of the internal member 50 and the seat (not shown) connected thereto to assist in the intended function of the seatpost assembly 48′ while the latching mechanism is in the released position and/or reduce the amount of motive force required to axially displace the inner member 50 in the extending direction 17. Alternatively, an extension spring may be substituted for compression spring 111, which would bias the internal member in the retracting direction 19. As a further alternative, a different type of device may be substituted for the spring 111, to provide a biasing motive force. Such a device may include magnets (for magnetic repulsion/attraction force), pressurized air storage, among others discussed herein and those known in industry.

It is noted that controller assembly 130 and seatpost assemblies 48 and 48′ shown in these figures are a schematic representations for explanatory purposes only. It is understood that further detail of these assemblies may be required for practical use.

FIGS. 3a-d describe a controller assembly 130 that may be utilized in conjunction with the seatpost assembly 48 or 48′. Controller assembly 130 includes: screw 144; knob 134; and base 132. Note that control rod assembly 80 is the same assembly utilized and shown in FIGS. 2a-w, however FIGS. 3a-d show its opposite end for connection with the controller assembly 130. Control rod assembly 130 further includes connector 86b fixed to the end portion 87b of the sheath 84, which is opposed to the end portion 87a that is connected to the seatpost assembly 48 or 48′.

Base 132 includes: a shaft 142 serving as an axle for rotation of the knob 134; a recess 146 to receive the spool 136 and the rod 82 wrapped around it as shown in FIG. 3d; hole 143 that is internally threaded to threadably receive screw 144; opening 133 to receive connector 86b; registration mark 140 for visual alignment feedback with the knob 134; and an opening 148 for secure mounting to an external element such as the handlebar of the same bicycle to which the associated seatpost assembly 48 or 48′ is mounted. Knob 134 is rotatable with respect to the base 132 about axis 135 and includes: notches 138 that may facilitate manual gripping and manipulation by the user's fingers; and spool 136 with groove 137 to provide position control of the rod 82 when it is wrapped around spool 136. The groove 137 extends circumferentially and serves to provide a nest to receive the rod 82 and includes a radial hole 141 to receive the finger 88 (shown in FIG. 3d) of the rod 82. Knob 134 also preferably includes numbers 139 or other markings to sequentially align with registration mark 140 as a means to provide visual feedback to the user that corresponds to the rotational position of the knob 134 relative the base 132, and correspondingly to the axial position of the internal member 50 to the external member 70.

During assembly of the controller assembly 130, the rod 82 of FIG. 3a is fed through opening 133 and into recess 146. The end of rod 82 is then bent to provide the finger 88, with the finger 88 then inserted in hole 141 as shown in FIG. 3d. The knob 134 is assembled to the base 132 in direction 149 such that the spool 136 is positioned within the recess 146 and the rod 82 is nested in groove 137. Connector 86b is anchored in opening 133. Screw 149 is then threadably assembled to hole 143 to secure the knob 134 to the base 132. The controller assembly 130 is complete and the knob 134 may now pivot around shaft 142 in rotary directions 150a and 150b relative to base 132.

As particularly shown in FIG. 3d, the rod is positioned within groove 137 and wrapped around the spool 136 such that rotation of the knob 134 in direction 150a will provide proportional linear displacement of the rod 82 in in direction 109a. Conversely, rotation of the knob 134 in direction 150b will provide proportional linear displacement of the rod 82 in direction 109b. As such, controller assembly is bi-directional where rotation of the knob 134 in direction 150a will serve to provide axial displacement in the extending direction 17 and rotation of the knob 134 in direction 150b will serve to provide axial displacement in the retracting direction 19. The notches 138 are shown to be arranged in a circular arrangement to create a circular user interface. It is understood that this user interface may alternatively have any other desirable shape, including a lever, etc.

The user may rotationally manipulate the knob 134 such that visual alignment of numbers 139 and registration mark 140 will provide visual feedback to the user corresponding to the linear displacement of the rod 82 in directions 109a (i.e. unspooling of rod 82) and 109b (i.e. reel-in of rod 82). It is preferred that incrementally advancing the knob 134 in directions 150a or 150b to visually align the next number will shuttle the rod 82 to correspondingly actuate the axial displacement to provide engagement with the next socket 73. As such, the visual alignment of a given number 139 with registration mark 140 corresponds to a given axial position of the internal member 50 that is locked by the latching mechanism. As such, it is preferred that the incremental angular spacing between sequential numbers 139 are associated with a linear displacement of rod 82 that corresponds to the incremental distance 69 of sockets. Each incremental position of the knob 134 corresponds to an incremental number 139 that also corresponds to engagement with incremental socket of the seatpost assembly 48. The controller assembly 130 is functional to allow the user to selectively manipulate and meter the linear position of rod 82 in directions 109a and 109b relative to the sheath 84 and correspondingly selectively advance the axial position of the internal member 50.

The control rod assembly 80 serves as a mechanical control link to communicate user input from the controller assembly 130 to the seatpost assembly 48, with the end portion 87a and connector 86a connected to the seatpost assembly 48 at one end of the control rod assembly 80 and with the end portion 87b, connector 86b, and finger 88 connected to the controller assembly 130 at the opposite end of the control rod assembly 80. The controller assembly 130 may then serve as a remote controller of the seatpost assembly 48 where input from the controller assembly 130 communicates to the seatpost assembly 48 through the control rod assembly 80. Linear displacement of the control rod 82 within the sheath 84 serves to provide linear displacement of the cam block 92, which serves to axially displace the internal member 50 in directions 17 and/or 19.

The controller assembly 130 also serves as an actuator that is remote and external to the seatpost assembly 48, where rotation of the knob 134 serves to provide the linear motion of the rod 82, which in turn, actuates the axial displacement of the internal member 50. The controller assembly 130 also serves to transmit the motive force provided by the user to drive the internal member 50 in directions 17 and/or 19. This actuation is a “linear” actuation in that actuation includes translational movement of the control rod 82 and/or the cam block 92. This is in contrast to rotational actuation, such as in U.S. Pat. No. 11,661,130, which relies on rotation of a motor. As described herein, the energy source for axial adjustment is provided by the user, who imparts motive force to the system by manually twisting the knob 134 by a predetermined amount. Correspondingly, the controller assembly 130 thereby actuates the axial displacement of the seatpost assembly 48, through the control rod assembly 80 and the aforementioned latching mechanism, to an axial position corresponding to the predetermined twist of the knob 134.

While the control rod assembly 80 serves as a mechanical link between the controller assembly 130 and the seatpost assembly 48, the embodiment of FIGS. 4a-j instead utilizes a hydraulic control link, including a hose assembly 190, to communicate user input between the controller assembly 198 and the seatpost assembly 158 and to provide motive force to extend and/or retract the seatpost assembly 158. Like the embodiment of 2a-w and 3a-d, manual manipulation of the controller assembly 198 serves to actuate the axial displacement of the internal member 160 via the hose assembly 190. Seatpost assembly 158 includes: an external member 180; an internal member 160; a cap 184; and a hose assembly 190.

The external member 180 is similar to external member 70 and includes: opening 181 to receive internal member 160; bushing 183 for guiding of internal member 160; axially extending grooves 182; and internal threads 185. Cap 184 includes external threads 187 to threadably mate with internal threads 185; and opening 186 to receive the fitting 194a of hose assembly 190. Cap 184 further includes a piston column 188 with piston seal 189 for hydraulic sealing with the cylinder bore 166.

Internal member 160 is a generally cylindrical element that includes four circumferentially spaced keys (not shown, but identical to keys 52) that are aligned to slide within grooves 182 to provide a guided and axially slidable bushing engagement between the internal member 1600 and external member 180 and also to limit and prevent circumferential rotation between the internal member 160 and external member 180 to maintain circumferential alignment therebetween as the seatpost assembly 158 is extended and retracted. It is preferred that the internal member 160 be of a lightweight high strength material such as aluminum or fiber-reinforced composite and that the keys be made of rigid lubricious material such as nylon or acetal polymer. Internal member 160 also includes: cylinder bore 166, bleeder passage 168 and bleeder screw 176.

Hose assembly 190 is of conventional configuration and includes a hydraulic hose 192 with two end fittings 194a and 194b fixed thereto as shown. As is conventional, end fittings 194a and 194b include external threads to threadably connect with openings 186 and 215 respectively.

These components are assembled as particularly shown in FIGS. 4d, 4e, and 4g to create seatpost assembly 158. Internal member 16 is sleevably inserted within opening 181 as shown such that keys (not shown) are axially guided within respective mating grooves 182 in a manner similar to that described in the embodiment of FIGS. 2a-w. End fitting 194a is threadably connected to the opening 186 of cap 184. Cap 184 is threadably assembled to external member 180, with threads 187 threadably engaged to threads 185 such that piston column 188, with seal 189 attached thereto, is inserted within cylinder bore 166. Seal 189 is shown here to be configured as a conventional U-cup seal to provide hydraulic piston sealing therebetween in the conventional manner. End fitting 194a is threadably connected with opening 186 in the conventional manner to provide hydraulic sealing therebetween.

Controller assembly 198 includes: a cylinder block 210 having a cylindrical cylinder 212, an opening 215, and internal threads 214; a piston shaft 200 having a knob 202 for manual manipulation by the user about rotation axis 222, helical external threads 204 to threadably mate with helical internal threads 214, and a swivel tip 205 to engage mating swivel socket 207; a piston 206 having a swivel socket 207 and a wiper seal 208. The controller assembly 198 is assembled as shown in FIGS. 4b and 4f. The swivel tip 205 is nested, captured, and engaged within swivel socket 207 to permit relative rotation therebetween about axis 222. Piston 206 is positioned within cylinder 212 such that seal 208 provides hydraulic piston sealing with the cylindrical walls of cylinder 212. Internal threads 214 are threadably mated with external threads 204. End fitting 194b is threadably connected with opening 215 in the conventional manner to provide hydraulic sealing therebetween.

It is noted that controller assembly 198 and seatpost assembly 158 shown in these figures are each schematic representations for explanatory purposes only. It is understood that further detail of these assemblies may be required for practical use. As shown in FIGS. 4d-h, hydraulic fluid 224 is included within the controller assembly 198, seatpost assembly 158, and hose assembly 190. Seatpost assembly 158 includes hydraulic cavity 226a and controller assembly 198 includes a hydraulic cavity 226b. Hydraulic cavities 226a and 226b communicate with each other through the flow and displacement of hydraulic fluid 224 in the hydraulic hose 190 as shown in FIGS. 4d and 4f. Bleeder screw 176 may be utilized in the conventional manner to bleed and remove any entrapped air or other compressible fluid from this hydraulic system.

It is preferred that hydraulic fluid 224 is generally incompressible. In operation, the user may rotatably manipulate the knob 202 in direction 230a, as shown in FIGS. 4h and 4g, to rotate external threads 204 within internal threads 214 to threadably advance the piston 206 in direction 228a, thereby reducing the volume of hydraulic cavity 226b and forcibly displacing hydraulic fluid 224 through hose assembly 190 and into hydraulic cavity 226a. This causes the volume of hydraulic cavity 226a to increase and drive cylinder bore 166 and internal member 160 in the extending direction 17 to an extended position indicated by dimension 178′ that is higher than dimension 178. Correspondingly, the height of the seat (not shown, but connected to internal member 160) has been raised. The thread engagement between external thread 204 and internal thread 214 supports any reverse flow of hydraulic fluid 224 without any change in volume of the hydraulic cavity 226b. As such, the incompressible hydraulic fluid 224 allows the volume of hydraulic cavity 226a and corresponding dimension 178′ to be maintained to support axial load 9. It may be interpreted that the controller 198 serves to latch and lock the flow and displacement of hydraulic fluid 224. Conversely, the user may rotatably manipulate the knob 202 in direction 230b, as shown in FIGS. 4d and 4f, to threadably retract the piston 206 in direction 228b, thereby increasing the volume of hydraulic cavity 226b and drawing hydraulic fluid 224 through hose assembly 190 and from hydraulic cavity 226a. This causes the volume of hydraulic cavity 226a to decrease and draw cylinder bore 166 and internal member 160 in direction 19 to a retracted position indicated by dimension 178 that is lower than dimension 178′. Correspondingly, the height of the seat (not shown) has now been lowered. Again, the hydraulic fluid 224 allows the volume of hydraulic cavity 226a and corresponding dimension 178′ to be maintained, thus supporting axial load 9.

In this manner, it may be considered that the controller assembly 198 includes a master cylinder and the seatpost assembly 158 includes a slave cylinder for hydraulic transmission of linear displacement therebetween. Such a master/slave cylinder function is understood in industry. The controller assembly 198 serves as an actuator to convert the manual manipulation of knob 202 into at least a portion of the motive force to displace the internal member 160 in directions 17 and/or 19. As described herein, the energy source for axial displacement is provided by the user, who imparts motive force to the system by manually twisting the knob 202 by a selected angle. Correspondingly, the controller assembly 198 thereby transfers this motive force, by selectively advancing and metering the flow of hydraulic fluid 224 in the hose assembly 190, to the to the piston/cylinder arrangement of the piston column 188 and cylinder bore 166, which serves to acuate the axial displacement of the seatpost assembly 158 to a corresponding selected axial position. It is preferred that this manual manipulation of knob 202 occur while the user is not seated on the seat (not shown), but once the desired axial height setting is achieved, the internal member 160 may support the axial load 9 associated with the user's weight when sitting on the seat.

It is noted that the embodiment of FIGS. 4a-j does not include a separate latching mechanism with a function similar to the latching mechanism described in the seatpost assembly 148 of FIGS. 2a-w. However, it may alternatively be preferable to incorporate a latching mechanism into the embodiment of FIGS. 4a-j. Such a latching mechanism may preferably be a hydraulic latching mechanism that is functional to regulate the flow of hydraulic fluid 224 between hydraulic cavities 226a and 226b and may comprise a hydraulic circuit including spool valve(s) and/or check valve(s) and/or other types of valves known in industry. These valve(s) may be biased by a spring toward a preferred position to limit or allow flow of hydraulic fluid 224 and/or may be electrically controlled by solenoid(s) electromagnet(s) and the like. This latching mechanism would be functional to restrict the flow of hydraulic fluid 224 initiated from axial load 9 applied to the seat (not shown) and/or internal member 160 in directions 17 and/or 19 and to permit flow of hydraulic fluid 224 initiated from the controller assembly 198 in directions 228a and/or 228b.

While my above description contains many specificities, these should not be construed as limitations on the scope of the invention, but as merely providing exemplary illustrations of some of the preferred embodiments of this invention. For example:

The present invention comprises a seatpost assembly having a first portion to which a seat may be mounted and a second portion that is fixed to a frame. The first and second portions may be arranged to be displaced relative to each other in generally parallel movement to adjust the height of the seat relative to the frame between an extended and raised position and a retracted and lowered position of the seat. This parallel movement is manifest as telescopic displacement in the embodiments of the present invention described herein. However, such parallel displacement may be achieved without a telescopic arrangement. For example, parallel displacement may be achieved by a 4-bar parallelogram linkage, including idler links between the first and second portions.

While not shown in FIGS. 4a-j, a spring or other biasing means may be incorporated into the seatpost assembly 158 that braces between the internal member 160 and external member 180 to bias the internal member 160 toward the retracting direction 19. This biasing means may be utilized to assist in displacing the internal member 160 when the hydraulic fluid 224 is de-pressurized while drawing the cylinder bore 166 in direction 19.

While FIGS. 2a-w and 3ad describe a mechanical connection (i.e. control rod assembly 80) between the controller assembly 130 and the seatpost assembly 48 and FIGS. 4a-j describe a hydraulic connection (i.e. hose assembly 190) between the controller assembly 198 and the seatpost assembly 158, it may be beneficial to alternatively include an electrical connection between the seatpost assembly and a controller that is external to and remote therefrom. In this case, the electrical connection, in the form of an electrical conductor such as a wire, may be utilized to remotely communicate the control of axial displacement. For example, the electrical connection may be utilized to control a solenoid to selectively lock and/or unlock axial displacement. Alternatively, wireless communication by a protocol such as Bluetooth® or Ant+® may be utilized for such communication and control.

While the embodiments of FIGS. 2a-w and 3a-d describe a direction connection between the manually manipulated knobs (134 and 202 respectively) and their actuator (spool 136 and piston 206 respectively), a ratcheting controller may alternatively be included in the controller assembly (130 and 198 respectively). An example of such an alternative arrangement may include a ratcheting lever to drive the knob, where the lever would be manually manipulated to control axial displacement. One example of such a ratcheting lever is commonly used in the indexing “thumb/trigger shifters” in the bicycle industry and may be adapted to provide a similar user interface to control and/or drive axial displacement. Such a ratcheting controller may provide improved ergonomics as compared with the rotary knobs (134 and 202).

While the embodiments of FIGS. 2a-w and 3a-d describe respective wrapped spool and helical thread engagement to drive and/or control axial displacement, a wide range of alternative mechanisms known I industry may alternatively be substituted for this purpose. For example, a rack-and-pinion mechanism may be incorporated into the controller and/or actuator to drive and/or control axial displacement. In one such an arrangement, the user may manipulate the pinion gear to linearly drive the rack gear with the control rod 82 affixed thereto.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications that are within its spirit and scope as defined by the claims.

1. A seatpost assembly comprising:
a first seatpost portion;
a second seatpost portion that is axially displaceable relative to said first seatpost portion along an axial axis in a retracting direction of increasing axial overlap with said first seatpost portion to a first axial position; and in an axially extending direction of decreasing axial overlap with said first seatpost portion to a second axial position that is axially retracted relative to said first axial position;
a motive force to drive said axial displacement;
wherein said range of axial displacement is between a fully extended axial position and a fully retracted axial position, with a mid-stroke axial position therebetween;
wherein said second seatpost portion is configured to include a seating surface;
wherein said motive force is an active motive force applied to actuate said second seatpost portion in one of said extending direction and said retracting direction;
including an actuator functional to convert said motive force into linear actuation of said axial displacement; and
wherein said actuator is external to said seatpost assembly.

2. The seatpost assembly according to claim 1, wherein said actuator may be selectively controlled to selectively displace said second seatpost portion in said extending direction.

3. The seatpost assembly according to claim 2, including a controller link between a controller and said actuator, wherein said controller link serves to communicate said selective control of said controller with said selective control of said actuator; wherein said controller is remotely positioned from said seatpost assembly and communicates with said actuator by at least one of a mechanical connection, a hydraulic connection, and an electrical connection.

4. The seatpost assembly according to claim 3, wherein said mechanical connection includes a rod that may be linearly shuttled within a sheath.

5. The seatpost assembly according to claim 3, wherein said hydraulic connection includes hydraulic fluid that may be displaced within a hose.

6. The seatpost assembly according to claim 3, wherein said controller may be manipulated to selectively control said motive force to displace said second seatpost portion said mid-position.

7. The seatpost assembly according to claim 3, wherein said controller includes a hydraulic master cylinder and said seatpost assembly includes a hydraulic slave cylinder, including a hydraulic link with hydraulic flow between said master cylinder and said slave cylinder.

8. The seatpost assembly according to claim 7, wherein said master cylinder includes a piston that is displaceable within a cylinder to variably adjust the hydraulic volume of said master cylinder, wherein said variable adjustment is advanced and/or retracted by linear displacement through a lever.

9. The seatpost assembly according to claim 1, including a controller, wherein said controller is remote from said seatpost assembly and said controller may be manipulated to provide said motive force, wherein said controller is a ratcheting controller, such that said controller may be displaced in an actuation direction and in a bypass direction opposed to said actuation direction, wherein said controller provides said actuation in said actuation direction without providing actuation in said bypass direction.

10. The seatpost assembly according to claim 1, including a controller, wherein said controller is remote from said seatpost assembly and said controller may be manipulated to provide said motive force, wherein said controller is a rotary controller, including said manual manipulation about a rotary axis.

11. The seatpost assembly according to claim 10, wherein said controller includes a spool, including a control rod that is circumferentially wrapped around said spool, wherein said spool is manually manipulated to reel-in and/or reel-out said control rod.

12. A seatpost assembly comprising:
a first seatpost portion;
a second seatpost portion that is axially displaceable relative to said first seatpost portion along an axial axis in a retracting direction of increasing axial overlap with said first seatpost portion to a first axial position; and in an axially extending direction of decreasing axial overlap with said first seatpost portion to a second axial position that is axially retracted relative to said first axial position;
a motive force to drive said axial displacement;
wherein said range of axial displacement is between a fully extended axial position and a fully retracted axial position, with a mid-stroke axial position therebetween;
wherein said second seatpost portion is configured to include a seating surface;
wherein said motive force is an active motive force applied to actuate said second seatpost portion in one of said extending direction and said retracting direction;
wherein said motive force is provided, at least in part, from an external source that is external to said seatpost assembly; and
wherein said external source includes manual manipulation.

13. The seatpost assembly according to claim 12, wherein said manual manipulation is selectively applied to correspondingly and incrementally advance said axial displacement in at least one of said extending direction and said retracting direction.

14. The seatpost assembly according to claim 12, including a controller, wherein said controller is remote from said seatpost assembly and wherein said controller may be manually manipulated to provide said motive force to advance said second seatpost portion in said extending direction.

15. The seatpost assembly according to claim 12, including a controller, wherein said controller is remote from said seatpost assembly and wherein said controller may be manually manipulated to provide said motive force, wherein said manual manipulation is bi-directional such that manipulation in a first direction serves to provide axial displacement in said extending direction and manipulation in a second direction serves to provide axial displacement in said retracting direction.

16. A seatpost assembly comprising:
a first seatpost portion;
a second seatpost portion that is axially displaceable relative to said first seatpost portion along an axial axis in a retracting direction of increasing axial overlap with said first seatpost portion to a first axial position; and in an axially extending direction of decreasing axial overlap with said first seatpost portion to a second axial position that is axially retracted relative to said first axial position;
a motive force to drive said axial displacement;
wherein said range of axial displacement is between a fully extended axial position and a fully retracted axial position, with a mid-stroke axial position therebetween;
wherein said second seatpost portion is configured to include a seating surface;
wherein said motive force is an active motive force applied to actuate said second seatpost portion in one of said extending direction and said retracting direction;
including a visual feedback indicator that corresponds to said axial position; and
wherein said visual feedback indicator is remote from said seatpost assembly.

17. The seatpost assembly according to claim 16, wherein said visual feedback includes a sequential numerical representation, wherein said sequential numerical representation corresponds to a sequential advancement of said axial displacement in at least one of said extending direction and said retracting direction.

18. The seatpost according to claim 16, wherein said visual feedback indicator is in a controller comprising a first controller portion having a first indicator marking and a second controller portion having a second indicator marking, wherein said first controller portion is displaceable relative to said second controller portion such that said visual feedback indicator includes the relative alignment of said first indicator marking relative to said second indicator marking.

19. A seatpost assembly comprising:
a first seatpost portion;
a second seatpost portion that is axially displaceable relative to said first seatpost portion along an axial axis in a retracting direction of increasing axial overlap with said first seatpost portion to a first axial position; and in an axially extending direction of decreasing axial overlap with said first seatpost portion to a second axial position that is axially retracted relative to said first axial position;
a motive force to drive said axial displacement;
wherein said range of axial displacement is between a fully extended axial position and a fully retracted axial position, with a mid-stroke axial position therebetween;
wherein said second seatpost portion is configured to include a seating surface;
wherein said motive force is an active motive force applied to actuate said second seatpost portion in one of said extending direction and said retracting direction;
wherein said motive force is provided, at least in part, from a controller external to said seatpost assembly;
wherein said controller may be selectively manipulated to meter said motive force;
wherein an incremental manipulation of said controller corresponds to an incremental axial displacement.

20. The seatpost assembly according to claim 19, wherein said motive force serves to selectively and incrementally advance said axial displacement to a mid-stroke position.

21. The seatpost assembly according to claim 19, wherein said motive force may be selectively manipulated in a first direction to incrementally advance said axial displacement in said extending direction and may be manipulated in a second direction opposed to said first direction to incrementally advance said axial displacement in said retracting direction.

22. A seatpost assembly comprising:
a first seatpost portion;
a second seatpost portion that is axially displaceable relative to said first seatpost portion along an axial axis in a retracting direction of increasing axial overlap with said first seatpost portion to a first axial position; and in an axially extending direction of decreasing axial overlap with said first seatpost portion to a second axial position that is axially retracted relative to said first axial position;
a motive force to drive said axial displacement;
wherein said range of axial displacement is between a fully extended axial position and a fully retracted axial position, with a mid-stroke axial position therebetween;
wherein said second seatpost portion is configured to include a seating surface;
wherein said motive force is an active motive force applied to actuate said second seatpost portion in one of said extending direction and said retracting direction;
including an actuator functional to convert said motive force into linear actuation of said axial displacement;
including a latching mechanism operable between a latched position to restrict said displacement of said second seatpost portion and a released position to permit said axial displacement of said second seatpost portion;
wherein said motive force serves to control the operation of said latching mechanism between said latched position and said released position.

23. The seatpost assembly according to claim 22, wherein said latching mechanism has an input portion and an output potion, wherein said motive force is applied to drive said input portion and said output portion provides a motive force to actuate said axial displacement, including lost motion between said input portion and said output portion, wherein said lost motion serves to at least one of (i) actuate said latched position, and (ii) actuate said released position.

24. The seatpost assembly according to claim 22, wherein said actuator serves to axially displace said second seatpost portion to a predetermined axial position, wherein said latched position is actuated by achievement of said predetermined axial position.

25. The seatpost assembly according to claim 22, wherein said latching mechanism includes at least one of a check valve, and a spool valve to control hydraulic flow.
